(19) United States
(12) Patent Application Publication
(10) Pub. No.: US 2011/0242164 A1
(43) Pub. Date: Oct. 6, 2011

(54) RECORDING APPARATUS AND RECORDING METHOD

(75) Inventors: YUKI MIURA, Toyoake-shi (JP); AKIKO NOGUCHI, Kasugai-shi (JP); HIDEKAZU KOMIYA, Nagoya-shi (JP)

(73) Assignee: BROTHER KOGYO KABUSHIKI KAISHA, Nagoya-shi (JP)

(21) Appl. No.: 13/071,690

(22) Filed: Mar. 25, 2011

(30) Foreign Application Priority Data
Mar. 31, 2010 (JP) 2010-081786

(51) Int. Cl. B41J 29/38

(52) U.S. Cl. 347/9

(57) ABSTRACT

This disclosure discloses a recording apparatus comprising: a placing device capable of placing a recording medium; a discharging device that discharges ink; a radiating device that radiates the ultraviolet rays; a driving device that moves said placing device; a batch control portion that controls said discharging device and said radiating device so as to discharge said ink and to radiate ultraviolet rays in a predetermined first radiation amount; a primary control portion that controls said discharging device and said radiating device so as to discharge said ink and to radiate ultraviolet rays in a second radiation amount; a secondary control portion that controls said driving device to a work area; and a tertiary control portion that controls said driving device and said radiating device so as to move said placing device to a processing area, and to radiate said ultraviolet rays till a predetermined curing stage is exceeded.

### CROSS-REFERENCE TO RELATED APPLICATION

The present application claims priority from Japanese Patent Application No. 2010-81786, which was filed on Mar. 31, 2010, the disclosure of which is incorporated herein by reference in its entirety.

### BACKGROUND OF THE INVENTION

1. Field of the Invention

The present invention relates to a recording apparatus in which ink is discharged onto a recording medium and ultraviolet rays are radiated to the ink on the recording medium and a recording method.

2. Description of the Related Art

There has been a recording apparatus provided with discharging device for discharging ink and radiating device for radiating ultraviolet rays to the discharged ink in a prior art. The discharging device discharges the ink to a recording medium placed by placing device so as to perform recording by printing. The radiating device radiates ultraviolet rays to the ink adhering to the recording medium. The ink adhering to the recording medium is cured by exposure to the ultraviolet rays.

The prior art recording apparatus can decorate the recording medium only by a type or a color of the ink and is capable only of monotonous expression by colors.

On the other hand, ink containing a decoration material such as lame may be used in order to improve decoration properties. However, this case has the following problems. In order to discharge the ink containing the decoration material through the discharging device, the size of the decoration material needs to be made smaller than a discharge outlet and the shape also needs to be close to a sphere, and whereby the size and the shape of the decoration material are limited. Also, since there is a fear that the discharging device cannot discharge the ink containing excessive decoration material, the content of the decoration material is also limited. Moreover, in the ink containing the decoration material, the decoration material floats in a liquid-state solvent constituting the ink, but if the ink is cured by the ultraviolet rays, the cured solvent covers the surface of the ink and most of the decoration material is to be located inside the cured solvent. Therefore, even if natural light or electric light hits the ink surface, it does not reach the decoration material, and the decoration material cannot fully exert the decoration function thereof. As mentioned above, even if the ink containing the decoration material is used, desired decoration properties cannot be necessarily obtained.

### SUMMARY OF THE INVENTION

The present invention has an object to enable decoration by a material other than ink and to provide a recording apparatus that can improve decoration properties and a recording method.

### Means for Solving the Problem

In order to achieve the above-described object, according to the first invention, there is provided a recording apparatus comprising: a placing device capable of placing a recording medium; a discharging device having a nozzle that discharges ink which progresses curing while generating adhesion upon a trigger of radiation of ultraviolet rays and has adhesion on an outer surface thereof till a predetermined curing stage; a radiating device that radiates the ultraviolet rays; a driving device that moves the placing device; a batch control portion that controls the discharging device and the radiating device so as to discharge the ink onto an outer surface of the recording medium placed by the placing device and to radiate ultraviolet rays in a predetermined first radiation amount to the ink adhering to the recording medium; a primary control portion that controls the discharging device and the radiating device so as to discharge the ink onto the outer surface of the recording medium placed by the placing device and to radiate ultraviolet rays in a second radiation amount smaller than the first radiation amount to the ink adhering to the recording medium instead of the batch control portion; a secondary control portion that controls the driving device so as to move the placing device, after the discharge of the ink and the radiation of the ultraviolet rays executed by control of the primary control portion, from a processing area capable of the discharge and the radiation to a work area where an operator can perform a spraying work of a solid element larger than a diameter of the nozzle to the adhering ink; and a tertiary control portion that controls the driving device and the radiating device so as to move the placing device from the work area to the processing area, after the movement of the placing device to the work area executed by the control of the secondary control portion, and to radiate the ultraviolet rays to at least a part of the outer surface of the ink of the recording medium till the predetermined curing stage is exceeded.

In order to achieve the above-described object, according to the sixth invention, there is provided a recording apparatus comprising: a placing device capable of placing a recording medium; a discharging device having a nozzle that discharges ink which progresses curing while generating adhesion upon a trigger of radiation of ultraviolet rays and has adhesion on an outer surface thereof till a predetermined curing stage; a radiating device that radiates the ultraviolet rays; a spraying device that splays a solid element larger than a diameter of the nozzle; a first control portion that controls the discharging device and the radiating device so as to discharge the ink onto an outer surface of the recording medium placed by the placing device and to radiate the ultraviolet rays in a radiation amount smaller than a radiation amount to achieve the predetermined curing stage to the ink adhering to the recording medium; a second control portion that controls the spraying device so as to spray the solid element to the adhering ink, after the discharge of the ink and the radiation of the ultraviolet rays executed by the control of the first control portion; and a third control portion that controls the radiating device so as to radiate the ultraviolet rays, after the spraying executed by the control of the second control portion till the predetermined curing stage is exceeded, to at least a part of the outer surface of the ink on the recording medium.

In order to achieve the above-described object, according to the 20th invention, there is provided a recording method comprising: a first step of discharging ink which progresses curing while generating adhesion upon a trigger of radiation of ultraviolet rays and has adhesion on an outer surface thereof till a predetermined curing stage, from a nozzle to an outer surface of a recording medium, and radiating the ultraviolet rays in a radiation amount smaller than a radiation amount to achieve the predetermined curing stage to the ink adhering to the recording medium; a second step of spraying a solid element larger than a diameter of the nozzle to the adhering ink, after the discharge of the ink and the radiation of the ultraviolet rays in the first step; and a third step of radiating the ultraviolet rays to at least a part of the outer surface of the ink on the recording medium, after the spraying in the second step till the predetermined curing stage is exceeded.

### BRIEF DESCRIPTION OF THE DRAWING

FIGS. 1A and 1B are a plan view and a front view, respectively, of an outline configuration of an entire inkjet recording apparatus, which is an embodiment of the present invention.

FIG. 2 is a perspective view illustrating a configuration of an essential part of an inkjet recording apparatus.

FIG. 3 is a side sectional view of a carriage by a III-III section in FIG. 2.

FIG. 4 is a side sectional view of a carriage by a IV-IV section in FIG. 2.

FIG. 5 is a block diagram illustrating a functional configuration of a control system of an inkjet recording apparatus.

FIG. 6 is a flowchart illustrating a control content executed by a CPU.

FIG. 7 is a flowchart illustrating a detailed content of each printing mode operation processing at Step S100.

FIG. 8 is a flowchart illustrating a detailed content of printing processing at Step S200.

FIG. 9 is a table illustrating an example of a data table including various printing settings.

FIG. 10 is a flowchart illustrating a detailed content of each printing mode operation processing in a variation in which a decoration material is automatically sprayed.

FIG. 11 is a flowchart illustrating a detailed content of each printing mode operation processing in a variation in which an excess decoration material is removed by an air flow.

FIG. 12 is a flowchart illustrating a detailed content of each printing mode operation processing in a variation in which decoration-material removing device other than a blower fan is used.

FIG. 13 is a diagram illustrating a state in which a decoration material adheres to an ink layer in a half-cured state.

### DETAILED DESCRIPTION OF THE PREFERRED EMBODIMENTS

An embodiment of the present invention will be described below referring to the attached drawings.

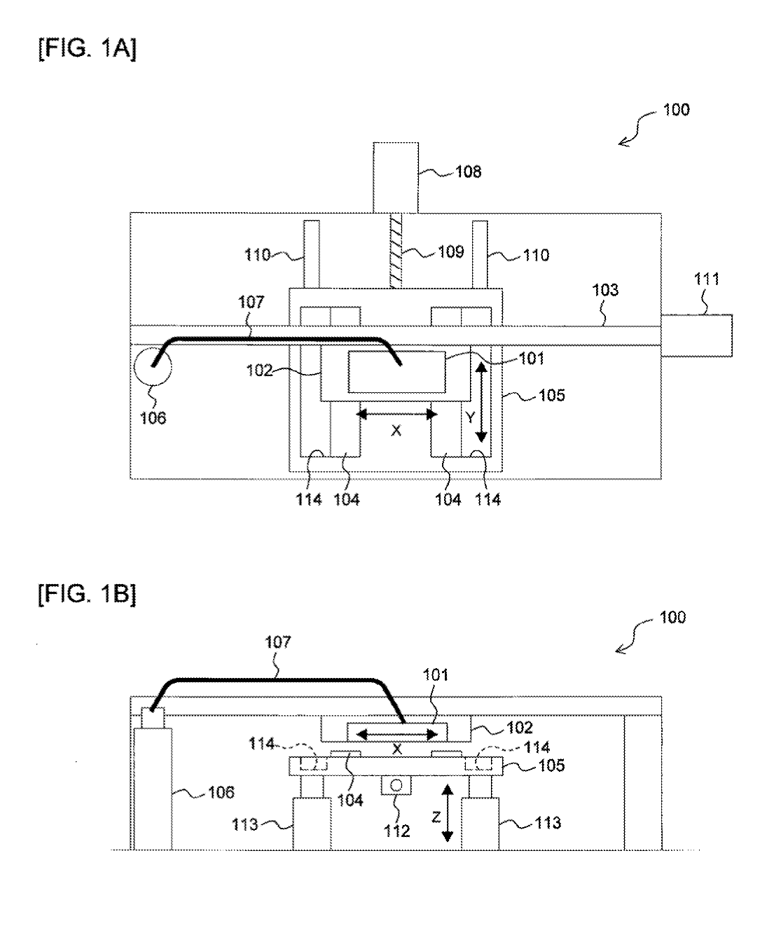

FIG. 1A is a plan view illustrating an outline configuration of an entire inkjet recording apparatus 100, which is an embodiment of a recording apparatus of the present invention, and FIG. 1B is a front view thereof. As shown in FIGS. 1A and 1B, the inkjet recording apparatus 100 includes a print head 101 for discharging ink, a carriage 102 on which the print head 101 is mounted, an X-axis guide bar 103 for guiding the carriage 102 in an X-axis direction, and an X-axis motor 111 for driving the carriage 102 along the X-axis guide bar 103. Also, the inkjet recording apparatus 100 includes a placing table 105 capable of placement of a print-receiving medium 104 such as paper or cloth, a Y-axis motor 108 for driving the placing table 105 in the Y-axis direction, a ball screw 109 connected to a rotation shaft of the Y-axis motor 108 and screwed with a bearing 112 on a lower face of the placing table 105, a guide rail 110 for guiding the placing table 105 in the Y-axis direction, and a vertical driving mechanism 113 for supporting the guide rail 110 and capable of driving the placing table 105 in a Z-axis direction by a built-in Z-axis motor (not shown). Also, the inkjet recording apparatus 100 includes an ink tank 106 containing the ink and a light-blocking ink tube 107 for supplying the ink to the print head 101 from the ink tank 106.

The placing table 105 is capable of placing the print-receiving medium 104 in a state fixed to an upper face thereof by air adsorption. In an example shown in FIGS. 1A and 1B, the placing table 105 places two print-receiving media 104 side by side in the X-axis direction. The placing table 105 has a flushing hole 114 for injecting the ink when flushing the print head 101 at both right and left side ends in the X-axis direction. Also, the ink contained in the ink tank 106 is UV ink which is cured while generating adhesion upon a trigger of radiation of ultraviolet rays and has adhesion on an outer surface till a predetermined curing stage. This is cationic ink containing at least one of epoxy compound, oxetane compound and vinyl ether compound, for example, and a polymerization initiator, sensitizer and the like. Thus, in the ink in this embodiment, loss of the adhesion on the outer surface progresses over time upon a trigger of radiation of the ultraviolet rays. The print head 101 discharges the ink to the print-receiving medium 104.

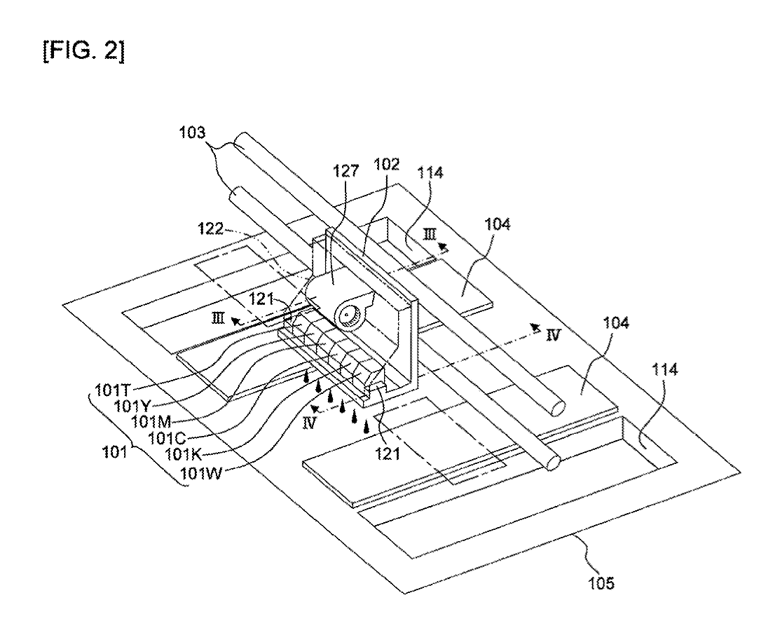

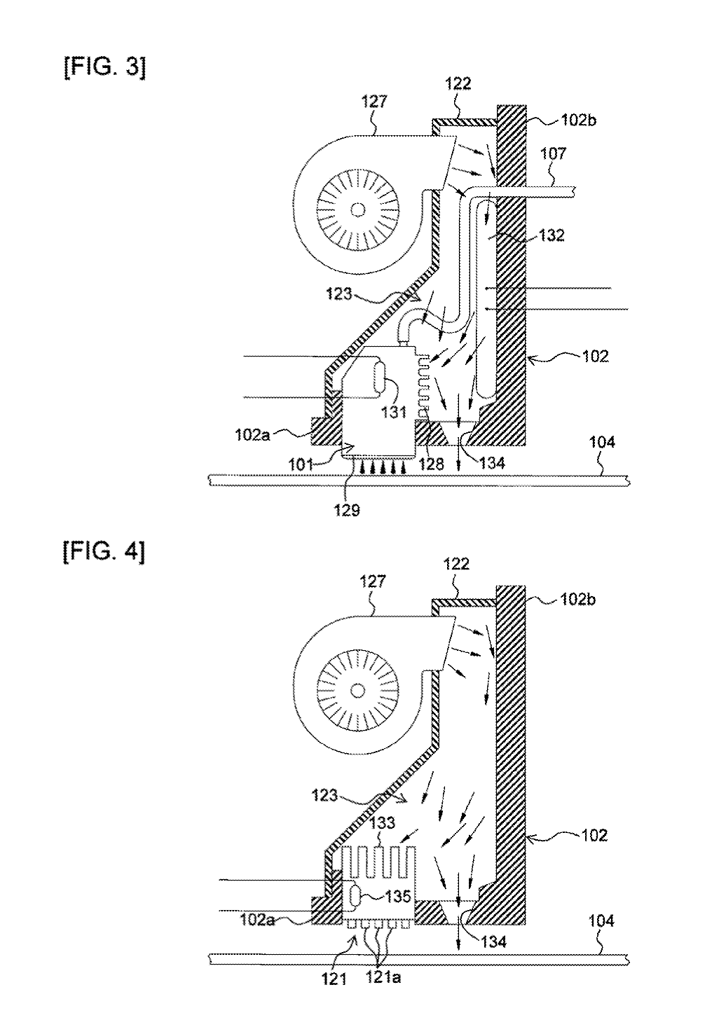

FIG. 2 is a perspective view illustrating a configuration of an essential part of the inkjet recording apparatus 100. FIG. 3 is a side sectional view of the carriage 102 by a III-III section in FIG. 2, and FIG. 4 is a side sectional view of the carriage 102 by a IV-IV section in FIG. 2.

As shown in FIGS. 2 to 4, the carriage 102 is a thermally-conductive member made of an aluminum alloy or the like having a substantially L-shaped side section. The carriage 102 has the print head 101 mounted in the vicinity of a front (left side in FIGS. 2 and 3) end portion of a horizontal portion 102a. The print head 101 has print heads 101Y, 101M, 101C, and 101K for discharging the ink in yellow, magenta, cyan, and black, and in addition, a print head 101T for discharging transparent ink and a print head 101W for discharging white ink. Also, the carriage 102 has UV radiating devices 121 for radiating ultraviolet rays mounted on both the right and left sides in the X-axis direction of the print head 101 so as to sandwich the print head 101 between them. The UV radiating device 121 has a plurality of UV-LEDs 121a aligned in a lattice state along the X-axis direction and the Y-axis direction on a lower face facing the print-receiving medium 104.

The carriage 102 has a duct cover 122 attached to the front face side so as to surround the print head 101 and the UV radiating device 121. The duct cover 122 and the carriage 102 form a chamber 123 surrounding the print head 101, the UV radiating device 121, and the ink tube 107.

The carriage 102 has a blower fan 127 at the upper center part of the duct cover 122. The blower fan 127 generates, as indicated by straight arrows in FIGS. 3 and 4, gas flow within the chamber 123. An air flow generated by the blower fan 127 cools the print head 101 and the UV radiating device 121 through a heat-exchange fin 128 provided on the back face of the print head 101 and a heat-exchange fin 133 provided on the upper face of the UV radiating device 121 and flows out to the print-receiving medium 104 from an injection outlet 134 provided on the rear side (right side in FIGS. 2 and 3) of the horizontal portion 102a.

The print head 101 includes a heater 129 in the vicinity of an ink discharge port. The heater 129 makes viscosity of the ink near the discharge port optimal for discharge by heating the vicinity of the ink discharge port of the print head 101. Also, the print head 101 has a thermistor 131 for detecting a temperature of the head. The UV radiating device 121 also has a thermistor 135 for detecting a temperature of the device. The thermistors 131 and 135 detect the temperatures of the print head 131 and the UV radiating device 121 and output results to a CPU 301, which will be described later. The CPU 301 controls driving of the blower fan 127 on the basis of the detection result and executes temperature control in the chamber 123 mainly for the print head 101 and the UV radiating device 121. Moreover, the carriage 102 has an auxiliary heater 132 in a vertical portion 102b erected at the rear end of the horizontal portion 102a. The auxiliary heater 132 plays an auxiliary function in the temperature control in the chamber 123.

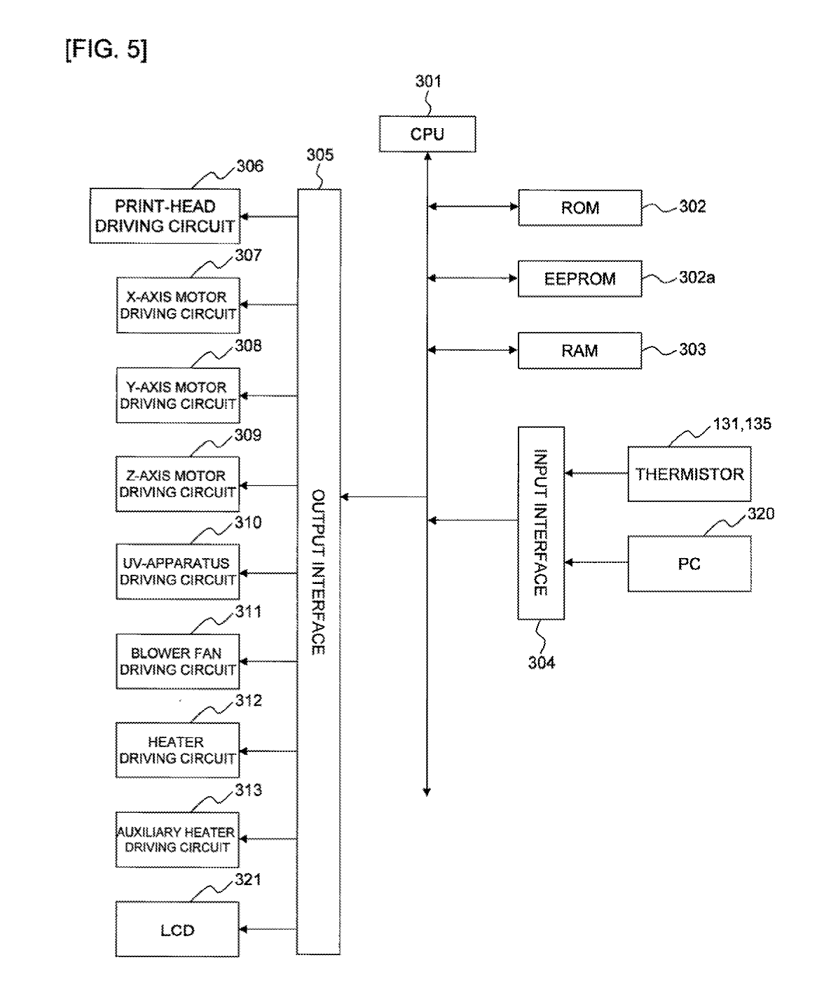

FIG. 5 is a block diagram illustrating a functional configuration of a control system of the inkjet recording apparatus 100. As shown in FIG. 5, the control system of the inkjet recording apparatus 100 mainly includes the CPU 301, a ROM 302, an EEPROM 302a, a RAM 303, an input interface 304, and an output interface 305. The output interface 305 is connected to a print-head circuit 306 for driving the print head 101, an X-axis motor driving circuit 307 for driving the X-axis motor 111, a Y-axis motor driving circuit 308 for driving the Y-axis motor 108, a Z-axis motor driving circuit 309 for driving the Z-axis motor of the vertical driving mechanism 113, an UV-device driving circuit 310 for driving the UV radiating device 121, a blower-fan driving circuit 311 for driving the blower fan 127, a heater driving circuit 312 for driving the heater 129, an auxiliary-heater driving circuit 313 for driving the auxiliary heater 132, and an LCD 321, which is a liquid crystal display provided in a PC 320 to be described later. The input interface 304 is connected to the PC (personal computer) 320 for making an input such as a printing start instruction, printing data and the like, and the above described thermistors 131 and 135.

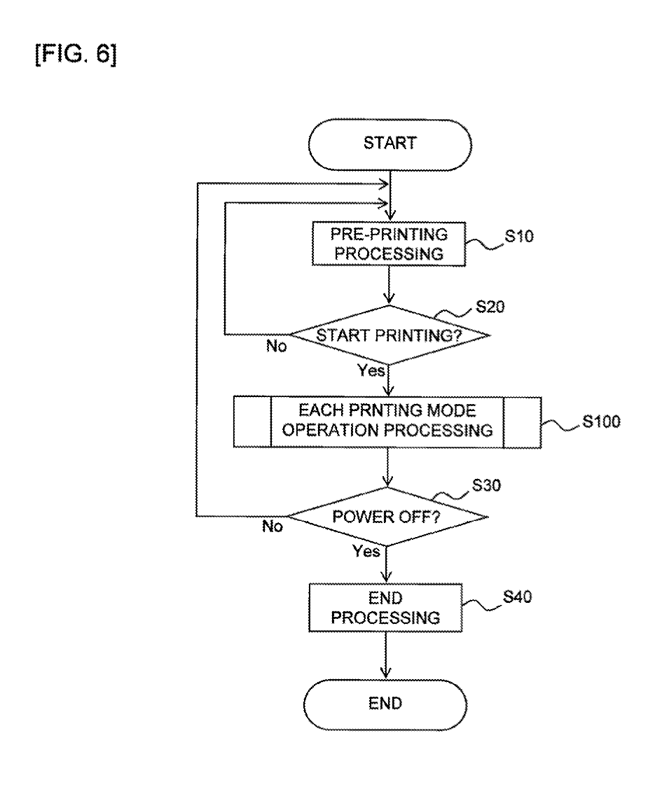

The ROM 302 stores various control programs and the like. The CPU 301 executes control contents shown in a flowchart in FIGS. 6 to 8 and the like, which will be described later by performing signal processing according to the control program stored in the ROM 302 while using a temporary storage function of the RAM 303.

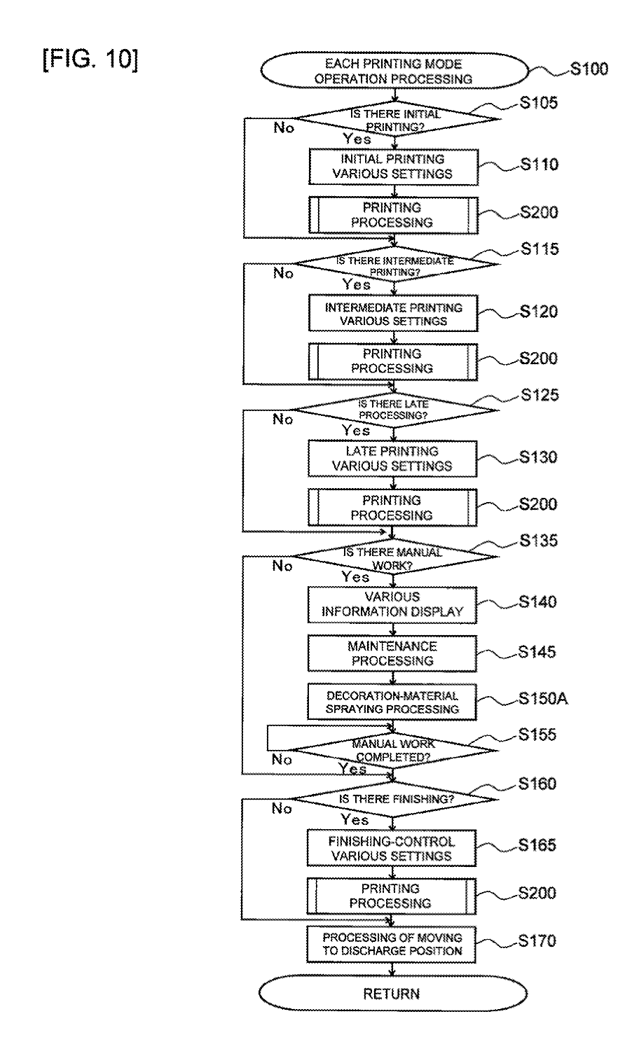

FIG. 6 is a flowchart illustrating the control contents executed by the CPU 301. As shown in FIG. 6, at Step S10, the CPU 301 performs pre-printing processing. The pre-printing processing is preprocessing of printing made on the basis of an operation signal that is input by an operator through operating means such as a keyboard or a mouse, not shown, of the PC 320, for selection of an image to be printed, arrangement and editing of the image, selection of a printing mode, change of various printing settings and the like. The printing mode is set in advance according to the various printing settings such as a type of the print-receiving medium 104, a constitution of a printing layer, a color and an amount of the ink, and ultraviolet rays radiation amount, and the RAM 303 stores the printing mode in a predetermined storage area as a data table (See FIGS. 9 and 10, which will be described later). The operator can perform printing with the printing settings corresponding to the printing mode by selecting a desired printing mode from the plurality of printing modes. Details of the printing mode will be described later. Note that the radiation amount is a radiation amount received by the ink forming a printing target until one printing target is completed by the inkjet recording apparatus 100, that is, an amount of the ultraviolet rays radiated in accumulation until one printing target is completed.

At the subsequent Step S20, the CPU 301 determines if the printing is to be started or not. The CPU 301 makes this determination by detecting if a printing start instruction has been input from the PC 320 or not. If the printing start instruction has not been input from the PC 320 yet, (NO at Step S20), the routine returns to Step S10. On the other hand, if the printing start instruction has been input from the PC 320 (YES at Step S20), the routine goes to Step S100.

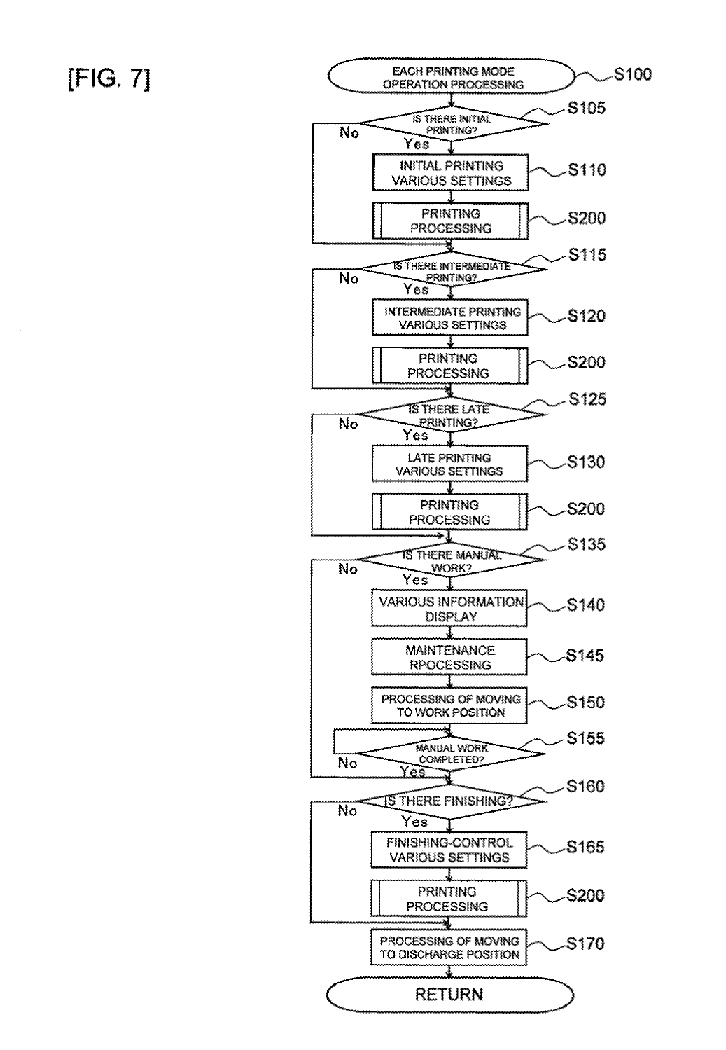

At Step S100, the CPU 301 executes each printing mode operation processing that executes printing on the print-receiving medium 104 according to the various printing settings set at Step S10 (for details, see FIG. 7, which will be described later).

At Step S30, the CPU 301 determines if the operator has performed a power OFF operation of the inkjet recording apparatus 100 or not. If the operator has not performed the power OFF operation (NO at Step S30), the routine returns to the preceding Step S10, and the processing similar to the above is repeated. On the other hand, if the operator has performed the power OFF operation (YES at Step S30), the routine goes to Step S40, and the CPU 301 executes end processing of the inkjet recording apparatus 100. The end processing includes shut-down of a running OS or application and the like, for example. This flowchart is finished as above.

FIG. 7 is a flowchart illustrating a detailed content of each printing mode operation processing at Step S100. As shown in FIG. 7, at Step S105, the CPU 301 determines if initial printing is to be performed or not. The initial printing is the first printing processing executed on the surface of the print-receiving medium 104. The CPU 301 reads, on the basis of the printing mode set in the pre-printing processing at the above described Step S10, information relating to a number of completions of corresponding initial printing (set number of times to perform the initial printing) from a predetermined storage area in the RAM 303 (hereinafter described as a storage area for the number of completions) and determines if the number of completions of the initial printing is larger than zero or not. If the number of completions of the initial printing is zero (NO at Step S105), it is considered that the initial printing is not to be performed, and the routine directly goes to Step S115, which will be described later. On the other hand, if the number of completions of the initial printing is larger than zero (YES at Step S105), it is considered that the initial printing is to be performed, and the routine goes to the subsequent Step S110.

At Step S110, the CPU 301 makes various settings relating to the initial printing. Specifically, on the basis of the printing mode set in the pre-printing processing at the above described Step S10, the CPU 301 reads the color setting, ink amount, ultraviolet rays radiation amount, number of completions and the like of the corresponding initial printing from the predetermined storage area in the RAM 303 so as to make the printing settings corresponding to the printing mode.

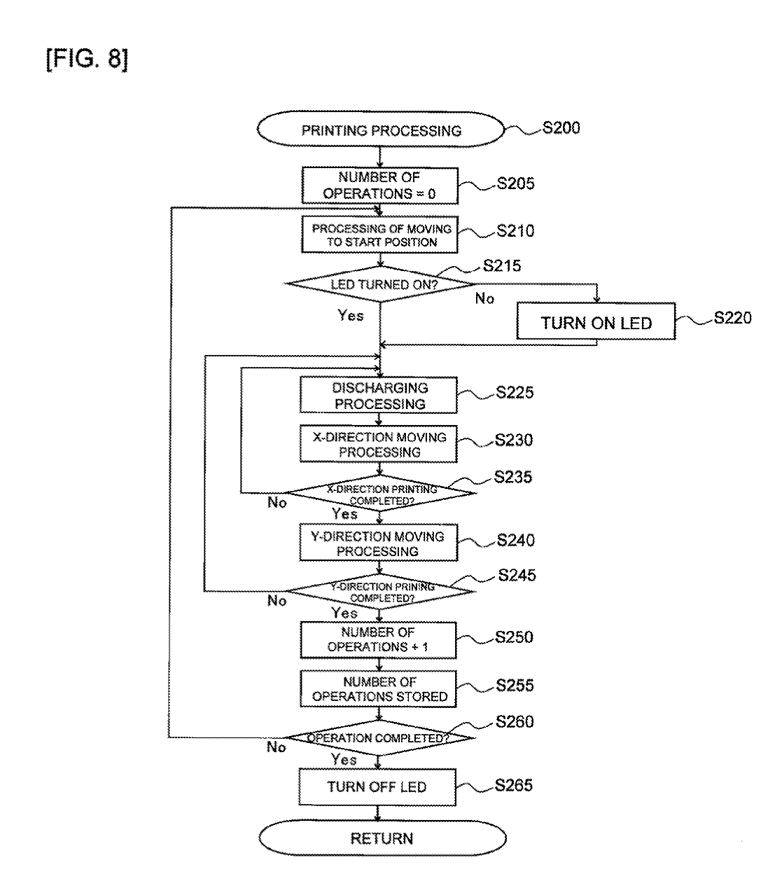

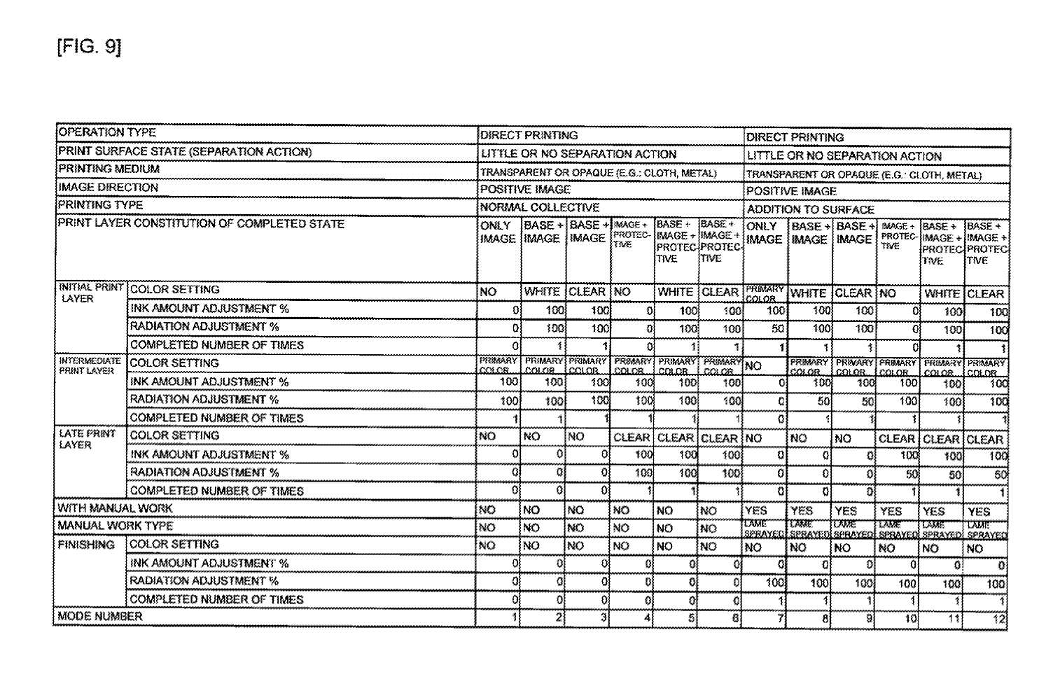

At Step S200, the CPU 301 moves the placing table 105 on which the print-receiving medium 104 is placed to a processing area (area shown in FIG. 1) where discharge of the ink by the print head 101 and ultraviolet-ray radiation by the UV radiating device 121 are possible, and executes the printing processing in which the initial printing on the basis of the printing setting set at Step S110 is performed the set number of completions (For details, see FIG. 8, which will be described later).

At Step S115, the CPU 301 determines whether to perform intermediate printing or not. The intermediate printing is the printing processing performed on the surface of the ink layer formed by the initial printing on the print-receiving medium 104 or the printing processing performed on the surface of the print-receiving medium 104 if the initial printing was not performed (if the number of completions of the initial printing is zero). The CPU 301 reads the information relating to the number of completions of the corresponding intermediate printing from the storage area of the number of completions of the RAM 303 on the basis of the printing mode set in the pre-printing processing at the above described Step S10 and determines if the number of completions of the intermediate printing is larger than zero or not. If the number of completions of the intermediate printing is zero (NO at Step S115), it is considered that the intermediate printing is not to be performed, and the routine directly goes to Step S125, which will be described later. On the other hand, if the number of completions of the intermediate printing is larger than zero (YES at step S115), it is considered that the intermediate printing is to be performed, and the routine goes to the subsequent Step S120.

At Step S120, the CPU 301 makes various printing settings relating to the intermediate printing similarly to Step S110.

At Step S200, the CPU 301 executes the printing processing to perform the intermediate printing on the basis of the printing settings set at Step S120 for the set number of completions (for details, see FIG. 8, which will be described later).

At Step S125, the CPU 301 determines whether to perform late printing or not. The late printing is the printing processing performed on the surface of the ink layer formed by the intermediate printing on the print-receiving medium 104 or the printing processing performed on the surface of the ink layer formed by the initial printing or the surface of the print-receiving medium 104 if the intermediate printing was not performed (if the number of completions of the intermediate printing is zero). The CPU 301 reads the information relating to the number of completions of the corresponding late printing from the storage area of the number of completions of the RAM 303 on the basis of the printing mode set in the pre-printing processing at the above described Step S10 and determines if the number of completions of the late printing is larger than zero or not. If the number of completions of the late printing is zero (NO at Step S125), it is considered that the late printing is not to be performed, and the routine directly goes to Step S135, which will be described later. On the other hand, if the number of completions of the late printing is larger than zero (YES at Step S125), it is considered that the late printing is to be performed, and the routine goes to the subsequent Step S130.

At Step S130, the CPU 301 makes various printing settings relating to the late printing similarly to Step S110.

At Step S200, the CPU 301 executes the printing processing to perform the late printing on the basis of the printing settings set at Step S130 for the set number of completions (for details, see FIG. 8, which will be described later).

At Step S135, the CPU 301 determines if a manual work by an operator is to be performed or not. The manual work here is a work of decoration using a material other than ink to the ink adhering to a predetermined portion of the print-receiving medium 104 in the middle of the printing, for example, spraying of a decoration material such as a lame. The CPU 301 reads the information relating to presence of the corresponding manual work from a predetermined storage area of the RAM 303 (hereinafter described as a storage area of presence of manual work) on the basis of the printing mode set in the pre-printing processing at the above described Step S10 and determines if there is a manual work or not. If there is no manual work (NO at Step S135), the routine directly goes to Step S160, which will be described later. On the other hand, if there is a manual work (YES at Step S135), the routine goes to the subsequent Step S140.

At Step S140, the CPU 301 outputs a display signal to the LCD 321 through the output interface 305 so as to display a variety of information. The information is, for example, information relating to finishing processing at Step S165 and Step S200, which will be described later, for example. Specifically, information such that finishing processing at the subsequent Step S165 and Step S200 starts on what hour and what minute and with what radiation amount is displayed.

At Step S145, the CPU 301 determines if the print head 101 is in a state requiring maintenance processing such as flushing or purge or not, and if yes, the maintenance processing is executed. The flushing is processing to remove clogging on a nozzle face caused by injection of the ink in the print head 101 into the above described flushing hole 114 at one time. Also, the purge is processing to suction the ink from the nozzle face of the print head 101 using a suction pump, not shown. By means of such maintenance processing performed by the operator in the manual work, time while the printing is not performed can be effectively used.

At Step S150, the CPU 301 outputs a driving signal to the Y-axis motor driving circuit 308 through the output interface 305 so as to drive the Y-axis motor 108 and the ball screw 109 and move the placing table 105 from the above described processing area to a work position while moving it along the Y-axis direction. When the placing table 105 is located at the work position, the upper face of the print-receiving medium 104 is exposed to the front side (lower side in FIG. 1A) of the inkjet recording apparatus 100, and the operator can perform the above described spraying work of the decoration material to the ink adhering to the predetermined portion in the print-receiving medium 104. Since the operator sprays the decoration material manually, unlike the case of using the ink containing the decoration material, for example, the decoration material larger than a diameter of the nozzle of the print head 101 can be sprayed. However, it is needless to say that the decoration material smaller than the nozzle diameter may be sprayed.

As mentioned above, in the inkjet recording apparatus 100, the print head 101 and the placing table 105, are configured to be able to move independently. Thus, the CPU 301 executes the maintenance processing at Step S145 and the processing of moving to work-position at Step S150 concurrently. As a result, an operation time can be reduced and processing efficiency can be improved.

At Step S155, the CPU 301 determines if the manual work by the operator has been completed or not. The CPU 301 makes this determination by detecting whether the operator has input a work completion signal through the operating means of the PC 320 or not. If the work completion signal is not detected (NO at Step S155), this step is repeated, while if the work completion signal is detected (YES at Step S155), the routine goes to the subsequent Step S160.

At Step S160, the CPU 301 determines if finishing for printing is to be performed or not. The finishing is processing to apply radiation of the ultraviolet rays and printing as necessary to the print-receiving medium 104 for which the initial printing, the intermediate printing, and the late printing have been finished and the manual work by the operator has been done, thereby performing the finishing of a series of printing processing. The CPU 301 reads information relating to the number of completions of the corresponding finishing from the storage area of the number of completions of the RAM 303 on the basis of the printing mode set in the pre-printing processing at the above described Step S10 and determines if the number of completions of the finishing is larger than zero or not. If the number of completions of the finishing is zero (NO at Step S160), it is considered that the finishing is not to be performed, and the routine directly goes to Step S170, which will be described later. On the other hand, if the number of completions of the finishing is larger than zero (YES at Step S160), it is considered that the finishing is to be performed, and the routine goes to the subsequent Step S165.

At Step S165, the CPU 301 makes various settings relating to the finishing control similarly to Step S110.

At Step S200, the CPU 301 executes the printing processing to perform the finishing on the basis of the control settings set at Step S165 only for the set number of completions (for details, see FIG. 8, which will be described later).

At Step 170, the CPU 301 outputs a driving signal to the Y-axis motor driving circuit 308 through the output interface 305 similarly to Step S150 so as to move the placing table 105 from the above described processing area to a discharge position while moving it along the Y-axis direction. When the placing table 105 is located at the discharge position, the operator can remove the print-receiving medium 104 from the placing table 105. As a result, this subroutine is finished.

Note that the work position where the operator can perform the spraying work of the decoration material and the discharge position where the print-receiving medium 104 can be removed from the placing table 105 may be the same or may be different. If the work position and the discharge position are the same, when some nonconformity (work failure or printing failure) occurs, for example, the operator can quickly remove the print-receiving medium 104 from the placing table 105. On the other hand, if the work position and the discharge position are different, by setting the discharge position on the inner side of the apparatus than the work position, for example, the work position is located on the outer side of the apparatus than the discharge position. Thus, when the placing table 105 has been moved to the work position, accidental removal by the operator, who mistook it as printing completion, of the print-receiving medium 104 from the placing table 105 can be prevented. Also, since the work position is located outside the apparatus, it has an effect that the operator can perform the spraying work of the decoration material more easily.

FIG. 8 is a flowchart illustrating a detailed content of the printing processing at Step S200. As shown in FIG. 8, at Step S205, the CPU 301 initializes the number of operations by storing the number “0” in a predetermined storage area of the RAM 303 (hereinafter described as an operation-times storage area). The number of operations is the number of times for which each printing processing (initial printing, intermediate printing, late printing, and finishing) is actually performed and is different from the above described number of completions determined for each printing mode described above (See FIGS. 9 and 10, which will be described later).

At Step S210, the CPU 301 outputs a driving signal to the X-axis motor driving circuit 307 through the output interface 305 and moves the print head 101 by moving the carriage 102 along the X-axis direction. Along with that, the CPU 301 outputs a driving signal to the Y-axis motor driving circuit 308 through the output interface 305 and moves the placing table 105 along the Y-axis direction. By means of such movement of the print head 101 in the X-axis direction and the placing table 105 in the Y-axis direction, the print head 101 is moved to the start position. The start position is a position above the printing start position for the print-receiving medium 104 placed on the placing table 105. As a result, the placing table 105 has moved to the processing area where discharge of the ink by the print head 101 and the ultraviolet-ray radiation by the UV radiating device 121 are possible.

At Step S215, the CPU 301 determines whether the UV-LEDs 121a in the UV radiating device 121 are turned on or not. The CPU 301 makes this determination by detecting if a radiation signal has been output or not to the UV-device driving circuit 310. If the UV-LEDs 121a are ON (YES at Step S215), the routine directly goes to Step S225. On the other hand, if the UV-LEDs 121a are not ON (NO at Step S215), the routine goes to Step S220, and the CPU 301 outputs the radiation signal to the UV-device driving circuit 301 through the output interface 305 so as to turn on the UV-LEDs 121a in the UV radiating device 121 and to start radiation of the ultraviolet rays. Then, the routine goes to Step S225.

The radiation amount of the UV radiating device 121 at Step S220 is determined for each printing mode set in the above described pre-printing processing at Step S10 (See FIGS. 9 and 10, which will be described later). The CPU 301 reads the corresponding radiation-amount information from a predetermined storage area of the RAM 303 (hereinafter described as a radiation-amount adjustment % storage area) on the basis of the set printing mode and performs radiation so as to supply the radiation amount.

At Step S225, the CPU 301 drives the pump, not shown, so as to supply the ink from the ink tank 106 to the print head 101 and also outputs a control signal to the print-head driving circuit 306 through the output interface 305 so as to discharge the ink to the print-receiving medium 104 from the print head 101. The ink amount at this time is determined for each printing mode set in the above described pre-printing processing at Step S10 (See FIGS. 9 and 10, which will be described later). The CPU 301 reads the corresponding ink-amount information from a predetermined storage area of the RAM 303 (hereinafter described as an ink-amount adjustment % storage area) on the basis of the set printing mode and discharges the ink so as to supply the ink amount.

At Step S230, the CPU 301 outputs a driving signal to the X-axis motor driving circuit 307 through the output interface 305 and moves the print head 101 in the X-axis direction by moving the carriage 102 along the X-axis direction. As a result, printing in the X-axis direction is performed.

At Step S235, the CPU 301 determines if the printing in the X-axis direction has been completed or not. The CPU 301 makes this determination by detecting if the carriage 102 has been moved to a predetermined position in the X-axis direction or not. If the printing in the X-axis direction has not been completed yet (NO at Step S235), the routine returns to Step S225, where the printing in the X-axis direction is continued. On the other hand, if the printing in the X-axis direction has been completed (YES at Step S235), the routine goes to the subsequent Step S240.

At Step S240, the CPU 301 outputs a driving signal to the Y-axis motor driving circuit 308 through the output interface 305 and moves the placing table 105 along the Y-axis direction. As a result, the placing table 105 is moved for one line in the Y-axis direction. At this time, if the surface of the print-receiving medium 104 has irregularity or the print-receiving medium 104 has a three-dimensional shape, for example, the CPU 301 also outputs a driving signal to the Z-axis motor driving circuit 309 as necessary and moves the placing table 105 in the Z-axis direction, too.

At Step S245, the CPU 301 determines if the printing in the Y-axis direction has been completed or not. The CPU 301 makes this determination by detecting if the placing table 105 has been moved to a predetermined position in the Y-axis direction. If the printing in the Y-axis direction has not been completed yet (NO at Step S245), the routine returns to Step S225, where the printing in the X-axis direction is continued. On the other hand, if the printing in the Y-axis direction has been completed (YES at Step S245), the routine goes to the subsequent Step S250.

The CPU 301 repeats the above described Step S225 to Step S245 till the printing in the Y-axis direction has been completed. During this period, after the carriage 102 is moved in the X-axis direction and the print head 101 discharges the ink for one line, movement of the placing table 105 for one line in the Y-axis direction and the discharge of the ink again for the subsequent line by the print head 101 are repeated.

At Step S250, the CPU 301 adds one to the number of operations stored in the storage area of the number of operations of the RAM 303 at Step S205 and updates contents of the storage area of the number of operations to the added number of operations at the subsequent Step S255.

At Step S260, the CPU 301 determines if the printing operation is to be completed or not. Specifically, the CPU 301 reads the information relating to the corresponding number of completions of printing from the storage area of the number of completions of the RAM 303 on the basis of the printing mode set in the above described pre-printing processing at Step S10 and determines if the number of operations stored in the storage area of the number of operations at Step S255 has reached the read number of completions or not. If the number of operations has not reached the number of completions yet (NO at Step S260), the routine returns to the preceding Step S210, where the similar procedure is repeated. On the other hand, if the number of operations has reached the number of completions (YES at Step S260), the routine goes to Step S265.

At Step S265, the CPU 301 outputs a stop signal to the UV-device driving circuit 310 through the output interface 305 so as to turn off the UV-LEDs 121a of the UV radiating device 121 and to stop the radiation of the ultraviolet rays. As a result, this subroutine is finished.

Subsequently, a specific operation performed by the inkjet recording apparatus 100 on the basis of the above described control contents will be described. FIG. 9 is a table illustrating an example of a data table including various printing settings. The RAM 303 stores this data table in a predetermined storage area.

The data table shown in FIG. 9 is a table when the inkjet apparatus 100 applies positive-image printing to the print-receiving medium 104, which is cloth, metal or the like. Among the printing modes shown in FIG. 9, the printing modes with mode numbers “1” to “6” are modes in which the manual work and finishing are not performed as shown in the figure. On the other hand, among the printing modes shown in FIG. 9, the printing modes with mode numbers “7” to “12” are modes in which both the manual work and the finishing are performed as shown in the figure. Therefore, these printing modes are modes to perform the discharge of the ink and the radiation of the ultraviolet rays by at least one of the initial printing, the intermediate printing, and the late printing, the movement of the placement table 105 at the above described Step S150 in order to perform the manual work, and the radiation of the ultraviolet rays at the above described Step S165 and Step S200 in order to perform finishing.

In the printing modes “1” to “6”, the ink in the initial printing, the intermediate printing, and the late printing is “fully cured”, while in the printing modes “7” to “12”, the ink in the final printing layer before the manual work in the initial printing, the intermediate printing, and the late printing is “half-cured” so that the decoration material such as a lame is made to adhere to the print-receiving medium 104 using the adhesion of the ink.

Here, the “fully cured” refers to a state in which the ink has been cured and lost its adhesion substantially fully and specifically to a state in which a tension load of the ink becomes zero in an evaluation by a tacking tester in compliance with JIS Z3284 if the ink is used as an adhesive. It is only necessary that the radiation amount for the “fully cured” is not less than a minimum value of the radiation amount when the “fully cured” state is obtained. The “half-cured” is a state in which the ink has not fully lost adhesion by curing and specifically a state in which the ink is cured by the radiation amount within a range of 0.05 to 0.95 times of the fully curing radiation amount, which is the minimum value of the radiation amount when the “fully cured” state of the ink is obtained.

A case in which the operator has selected the printing mode “7” in FIG. 9 will be described below. If the operator has selected the printing mode “7” through the operating means such as a keyboard or a mouse, not shown, of the PC 320, the CPU 301 inputs a signal that specifies the mode through the input interface 304 at Step S10 shown in FIG. 6 and sets the printing mode to “7”. It may also be so configured that instead of the mode selection operation by the operator as above, when, for example, image data includes data specifying the mode and the operator selects an image to be printed, the CPU 301 sets the mode according to the data included in the image data.

After that, if the operator places the print-receiving medium 104 on the placing table 105 and inputs a printing start instruction through the PC 320 (YES at Step S20), the routine goes to Step S100, where the CPU 301 executes each printing mode operation processing. In the printing mode “7”, since the number of completions of the initial printing is “1” (YES at Step S105), at Step S110, the CPU 301 makes various settings of the initial printing corresponding to the printing mode “7”. Specifically, as shown in FIG. 9, the CPU 301 sets color setting of the initial printing to primary colors (yellow, magenta, cyan, black or white), which are colors according to the image data, the ink-amount adjustment % to 100%, and the radiation-amount adjustment % to 50%. Then, at Step S200, the CPU 301 executes one session of the initial printing processing on the basis of the printing settings.

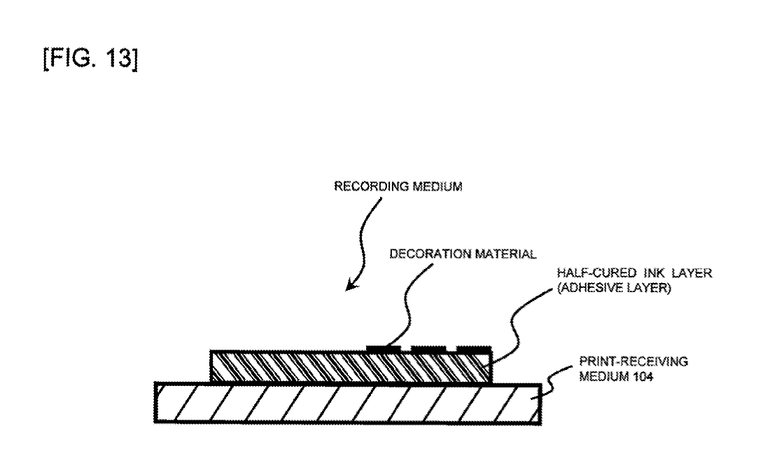

The value of the ink-amount adjustment % is a value if the ink amount in order to complete the printing processing in one session of the printing while being fully cured is 100%, and the value of the radiation-amount adjustment % is a value if the above described fully-curing radiation amount (the minimum value of the radiation amount when the ink is “fully cured”) is 100%. In the printing mode “7”, since the radiation amount of the initial printing is set to 50% of the fully curing radiation amount, the ink in the initial printing is brought to the “half-cured” state, and as shown in FIG. 13, the decoration material can be made to adhere to the print-receiving medium 104 as will be described later using the adhesion of the ink. That is, the printing layer formed in the initial printing functions as an adhesive layer.

In the above, the radiation amount in order to make the ink “half-cured” is set at 50% of the fully curing radiation amount, but not limited to that, the radiation amount may be within a range of 5 to 95% of the fully curing radiation amount. The lower limit value is set at 5% because with a value lower than that, the ink becomes a state close to a liquid and the adhesion cannot be obtained, and if the decoration material such as a lame is given onto that, the decoration material sinks into the ink, by which the intended decoration cannot be achieved. The upper limit value is set to 95% because with a value larger than that, the ink is brought into a state close to the “fully cured” and the adhesion cannot be obtained in this case, either.

Subsequently, in the printing mode “7”, since the number of completions in the intermediate printing and the late printing is “0” (NO at Step S115 and Step S125), the CPU 301 moves the processing to Step S135 without performing the intermediate printing and the late printing. In the printing mode “7”, since the manual work is “Yes” (YES at Step S135), at Step S140 and Step S145, the CPU 301 makes various information display and executes the maintenance processing as necessary. At this time, as mentioned above, at Step 140, the CPU 301 displays the information relating to the finishing processing at Step S165 and Step S200 on the LCD 321. Specifically, the information such that the subsequent finishing processing starts on what hour and what minute and with what radiation amount is displayed. As a result, the operator can reliably know time targets such that the time when spraying work of the decoration material should be started.

After that, at Step S150, the CPU 301 moves the placing table 105 from the processing area to the work position. At this time, since the type of the manual work is “lame spraying” in the printing mode “7”, the operator performs the decoration by spraying the lame so as to make it adhere to the exposed print-receiving medium 104. As a result, the decoration properties of the print-receiving medium 104 after the printing can be improved. Note that the decoration material is not limited to the lame but may be spangles or the like, for example. Alternatively, it may be made of metal (including deposited ones), ceramic, organic materials, and resins and formed in at least one of the shapes of a foil (including those aluminum-deposited), powders, beads, and fibers.

When the work is completed and the operator has input the fact through the operating means of the PC 320 (YES at Step S155), the CPU 301 moves the processing to Step S160. Then, since the number of completions of the finishing is “1” in the printing mode “7” (YES at Step S160), at Step S165, the CPU 301 makes various settings for the finishing control corresponding to the printing mode “7”. Specifically, as shown in FIG. 10, the CPU 301 sets the ink-amount adjustment % to 0% and the radiation-amount adjustment % to 100%. Then, at Step S200, the CPU 301 executes one session of the finishing printing processing on the basis of the printing settings.

Since the color setting of the finishing is “No” and the ink-amount adjustment % is “0” in the printing mode “7”, the ink is not discharged in the finishing printing processing. Also, since the radiation amount for the finishing is set at 100%, which is the fully curing radiation amount, as described above, the ink which has been “half-cured” in the initial printing is “fully cured” in the finishing printing processing. As a result, the decoration material made to adhere to the print-receiving medium 104 in the half-cured state can be fixed by the curing of the ink after that.

Subsequently, a case in which the operator has selected a batch recording mode or the printing mode “5” in FIG. 9, for example, will be described. In this printing mode “5”, the numbers of completions in the initial printing, the intermediate printing, and the late printing are all “1” (YES at Step S105, Step S115, and Step S125), the manual work is “No” (NO at Step S135), and the number of completions of the finishing is “0” (NO at Step S160), and thus, the CPU 301 makes various printing settings corresponding to the printing mode “5” at Step S110, Step S120, and Step S130 and performs the initial printing, the intermediate printing, and the late printing one session each on the basis of the printing settings at Step S200, respectively. Here, since the radiation amounts for all of the initial printing, the intermediate printing, and the late printing are set at 100%, which is the fully curing radiation amount, the ink in each printing is brought into the “fully cured” state. After that, at Step S170, the CPU 301 moves the placing table 105 from the processing area to the discharge position.

In the inkjet recording apparatus 100 in the embodiment described above, in the printing modes “7” to “12” shown in FIG. 9, after the discharge of the ink and the radiation of the ultraviolet rays on the basis of the initial printing, the intermediate printing, and the late printing, at Step S150, the CPU 301 moves the placing table 105 from the processing area to the work position. The operator can perform the spraying work of the decoration material such as a lame to the ink in a state with adhesion and adhering to the print-receiving medium 104 placed on the moved placing table 105. After the movement of the placing table 105 to the work position and the spraying work, at Step S165 and Step S200, the CPU 301 moves the placing table 105 again from the work position to the processing area. The UV radiating device 121 radiates the ultraviolet rays again to at least a part of the outer surface of the ink on the print-receiving medium 104 placed on the moved placing table 105 and cures the ink till the predetermined curing stage is exceeded so that the adhesion of the ink on which the decoration material has been sprayed is lost. As mentioned above, according to the inkjet recording apparatus 100 of this embodiment, after the operator has sprayed the decoration material to the ink with adhesion during progress of curing by the radiation of the ultraviolet rays and fixed it, the ultraviolet rays can be further radiated for curing. Unlike a prior art method of decoration only by the type and color of the ink, decoration with a material other than ink can be realized, and whereby decoration properties can be improved.

Moreover, since the operator can spray the decoration material manually in this embodiment, the following effects can be also obtained. If the ink containing the decoration material such as a lame is used in order to improve the decoration properties, for example, the size of the decoration material needs to be made smaller than the nozzle diameter in order to discharge the ink through the nozzle of the print head 101, and the shape also needs to be close to a sphere. Thus, the size and the shape of the decoration material are limited. Also, since there is a fear that the print head 101 cannot discharge the ink if the ink contains excessive decoration material, the content of the decoration material is also limited. On the other hand, since the operator makes the decoration material adhere manually in this embodiment, the size, the shape, and the amount of the decoration material are not limited as above, and a decoration material larger than the nozzle diameter, for example, can be also made to adhere. As mentioned above, since the operator can make the decoration material of a desired size and shape adhere in a desired amount, the decoration properties can be further improved.

Also, in the ink containing the decoration material, the decoration material floats in the liquid-state solvent constituting the ink, but if the ink is cured by the ultraviolet rays, the cured solvent covers the surface of the ink and most of the decoration material is located inside the cured solvent. Thus, even if natural light or electric light hits the ink surface, the light amount is weakened or randomly reflected by the cured solvent itself before it reaches the decoration material. Even if the light reaches the decoration material, the light amount of reflection light is weakened by the cured solvent itself or randomly reflected in the cured substance. From this fact, the decoration function cannot be fully exerted with the ink containing the decoration material. On the contrary, in this embodiment, since the operator makes the decoration material adhere to the outer surface of the print-receiving medium 104, the decoration material is not located inside the cured solvent but can fully exert the decoration function.

Also, even if usual ink is used and the decoration material is sprayed to the ink immediately after the discharge and then, the ink is cured by radiation of the ultraviolet rays, since the ink immediately after the discharge is liquid-state, the decoration material somewhat sinks into the ink and is fixed in that state. On the contrary, in this embodiment, in the state in which the ink is “half-cured”, the operator sprays the decoration material and fixee it, and thus, the decoration material does not sink into the ink and the decoration properties can be further improved.

Also, particularly in this embodiment, if the decoration material is not to be sprayed, the batch recording modes of the printing modes “1” to “6” shown in FIG. 9 are used. In these printing modes, the ultraviolet rays are radiated till the predetermined curing stage is exceeded so that the ink can be fully cured. On the other hand, if the decoration material is to be sprayed, the multi-stage recording modes of the printing modes of “7” to “12” shown in FIG. 9 are used. In these printing modes, since the decoration material is sprayed in a state in which the ultraviolet rays are radiated till the predetermined curing stage so that the adhesion remains in the ink, the decoration material can be reliably fixed by the adhesion of the ink.

Also, particularly in this embodiment, at Step S265, the CPU 301 stops the radiation of the ultraviolet rays by the UV radiating device 121 before the placing table 105 moves to the work position at Step S150. As a result, useless radiation by the UV radiating device 121 in a state in which the print-receiving medium 104 has been moved to the work position can be prevented.

Also, particularly, in this embodiment, at Step S145, the CPU 301 performs the predetermined maintenance operation for the print head 101 in a state in which the placing table 105 has been moved to the work position. As a result, utilizing the state in which the print-receiving medium 104 has moved to the work position and not present in the processing area, the maintenance such as flushing, purge and the like of the print head 101 can be performed.

Also, particularly in this embodiment, at Step S140, the CPU 301 displays the information relating to the finishing processing at Step S165 and Step S200 on the LCD 321. In order to fix the decoration material to the ink in a desired form, it is preferable to know when and how to start the radiation after the decoration material is sprayed, for example. In this embodiment, since the information relating to the finishing processing is displayed on the LCD 321 as described above, the operator can reliably know a time target for the above, for example.

Also, particularly in this embodiment, at Step S230 and Step S240, the CPU 301 controls such that the print-receiving medium 104 placed on the placing table 105 and the UV radiating device 121 are relatively moved. As a result, the UV radiating device 121 can radiate the ultraviolet rays to the ink at various angles. As a result, even if the decoration material is located on the outer surface of the ink, the radiation can be reliably made to the ink portion on the back side of the decoration material at an angle not shielded by the decoration material, and the ink can be efficiently cured.

Also, particularly in this embodiment, the print head 101 discharges the cation ink containing at least one of an epoxy compound, an oxetane product, and vinyl ether product, a polymerization initiator, and a sensitizer. By using the cation ink as above and by radiating the ultraviolet rays, the adhesion of the ink can be made to be lost from the outer surface and the ink can be cured over time.

Also, particularly in this embodiment, in the finishing processing at Step S165 and Step S200, the CPU 301 controls the UV radiating device 121 so that the ultraviolet rays are radiated till the stage in which the tension load of the ink becomes zero in the evaluation by a tacking tester in compliance with JIS Z3284 as the predetermined curing stage is exceeded. As a result, the ink is brought into the “fully cured” state, and the sufficient cured state of ink can be obtained.

Also, particularly in this embodiment, in the initial printing, the intermediate printing, and the late printing, the CPU 301 controls the UV radiating device 121 so that the radiation amount within the range of 0.05 to 0.95 times of the fully curing radiation amount is radiated. As a result, the ink is brought into the “half-cured” state, and the ink cured state in which the adhesion is reliably left can be obtained.

Also, particularly in this embodiment, the decoration material is made of ceramic, resin or metal and is formed in the shape of at least one of a particle, a film, a powder and a fiber. By performing decoration using the decoration material made of various materials as described above, the decoration properties can be improved.

The present invention is not limited to the above embodiment but is capable of various variations in a range not departing from its gist and technical idea thereof. Such variations will be described below in order.

(1) If the decoration material is automatically sprayed:

In the above embodiment, the operator sprays the decoration material manually, but not limited to that, the decoration material may also be automatically sprayed.

The inkjet recording apparatus 100 in this embodiment includes a spraying device (not shown) capable of spraying the decoration material onto the print-receiving medium 104 placed on the placing table 105 in the vicinity of the carriage 102, for example. As this spraying device, an injecting device that injects the decoration material using a compressed air or a sieve device that sprays the decoration material by vibrating a sieve, for example, can be employed.

FIG. 10 is a flowchart illustrating a detailed content of each printing mode operation processing in this variation and corresponds to the above described FIG. 7. In FIG. 10, a difference from the above described FIG. 7 is that Step S150A is provided instead of Step S150. That is, in this variation, at Step S135, the CPU 301 determines if there is a manual work by the operator or not, and if yes (YES at Step S135), at Step S140 and Step S145, the CPU executes various information display and the maintenance processing.

After that, at Step S150A, the CPU 301 outputs a driving signal to a spraying-device driving circuit (not shown) through the output interface 305 so as to drive the spraying device to spray the decoration material. Since the CPU 301 executes this decoration material spraying processing while locating the placing table 105 to the processing area, the CPU does not move the placing table 105 to the work position as in the above described embodiment. The procedures at the subsequent Step S160 and after are the same as those in FIG. 7. Also, the other control content executed by the CPU 301 is the same as that in the above described embodiment.

According to this variation, after the decoration material is automatically sprayed and fixed to the ink with adhesion during progress of curing by the radiation of the ultraviolet rays, the ultraviolet rays are further radiated so as to cure the ink. Unlike a prior art method of decoration only by the type and color of the ink, decoration with a material other than ink can be realized, and whereby decoration properties can be improved. Also, since the decoration material is automatically sprayed, a work burden can be alleviated as compared to the case of the manual spraying work by the operator. Moreover, since movement of the placing table 105 is smaller as compared to the manual work case, printing processing time can be reduced.

In this variation, it may be so configured that the CPU 301 changes the radiation amounts in the initial printing, the intermediate printing, and the late printing in accordance with the amount of the decoration material to be sprayed by the spraying device. If a spraying amount by the spraying device is large, for example, by controlling the UV radiating device 121 so that the radiation amounts in the initial printing, the intermediate printing, and the late printing becomes small, the cured degree of the ink is lowered and the adhesion is raised so that more decoration materials can be reliably fixed. Also, if the spraying amount by the spraying device is small, by controlling the UV radiating device 121 so that the radiation amounts in the initial printing, the intermediate printing, and the late printing becomes large, the cured degree of the ink is increased and the adhesion is lowered so that fixation with priority to quicker curing can be realized.

(2) If an excess decoration material is removed by the air flow:

In the above described embodiment, the operator sprays the decoration material manually, but since it is performed manually, the spraying amount of the decoration material can be excessive. In this case, if the printing processing is proceeded with as it is, the excessive decoration material shields the ultraviolet rays in the subsequent finishing processing and there is a fear that the ink is not properly cured. In this variation, in order to prevent such situation, the excessive decoration material is removed by an air flow by the blower fan 127.

As described above, the carriage 102 of the inkjet recording apparatus 100 has the blower fan 127 at the upper center part of the duct cover 122. The air flow by this blower fan 127 cools the print head 101 and the UV radiating device 121 through the heat-exchange fin 128 provided on the back face of the print head 101 and the heat-exchange fin 133 provided on the upper face of the UV radiating device 121 and then, flows out toward the print-receiving medium 102 from the injection outlet 134 provided on the rear side of the horizontal portion 102a. In this variation, the excessive decoration material is removed by using this flown-out gas.

A fan with an exclusive purpose of removing the decoration material may be separately provided instead of using the blower fan 127. As the fan, not only a blowing type but also a suction type can be employed.

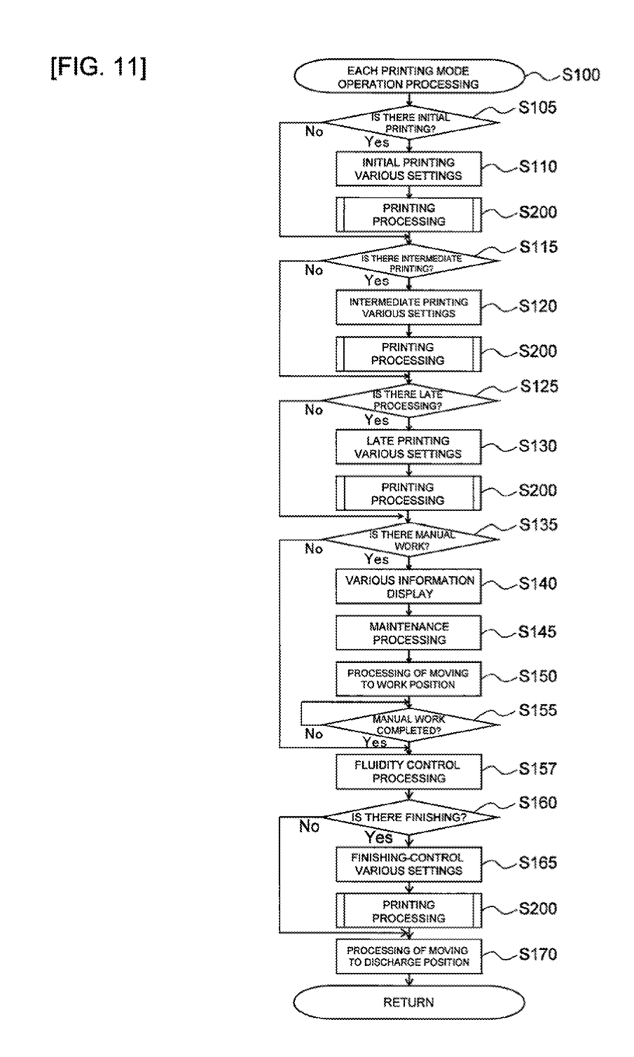

FIG. 11 is a flowchart illustrating a detailed content of each printing mode operation processing in this variation and corresponds to the above described FIG. 7. In FIG. 11, a difference from the above described FIG. 7 is that Step S157 is added. That is, in this variation, at Step S155, the CPU 301 determines if the manual work by the operator has been completed or not, and if the operator has input a work completion signal through the operating means of the PC 320 (YES at Step S155), the routine goes to Step S157.

At Step S157, the CPU 301 outputs a driving signal to the blow-fan driving circuit 311 through the output interface 305 so as to drive the blower fan 127. As a result, gas flow is generated in the chamber 123 and it flows out toward the print-receiving medium 104 through the injection outlet 134. At this time, since the excessive decoration material is not in contact with the “half-cured” ink and does not adhere to the ink, the decoration material can be easily removed by the injected gas. The procedures at the subsequent Step S160 and after are the same as those in FIG. 7. Also, the other control contents executed by the CPU 301 are the same as those in the above described embodiment.

According to this variation, shielding of the ultraviolet rays by the decoration material can be prevented by removing the excessive decoration material by blowing the gas by the blower fan 127, and the ink can be efficiently cured.

As described above, the CPU 301 controls the driving of the blower fan 127 on the basis of the detection result of the thermistors 131 and 135 and executes the temperature control in the chamber 123 mainly for the print head 101 and the UV radiating device 121. Therefore, though not particularly shown in FIG. 11, in the initial printing, the intermediate printing, and the late printing, too, the CPU 301 drives the blower fan 127 as appropriate so as to cool the print head 101 and the UV radiating device 121. In this cooling processing in the initial printing, the intermediate printing, and the late printing, as for the radiation time of the ultraviolet rays by the UV radiating device 121, the CPU 301 controls the UV radiating device 121 so that the gas is made to flow toward the UV radiating device 121. As mentioned above, according to this variation, since the blower fan 127 can be used both as the removing mechanism and the cooling mechanism, the apparatus configuration can be simplified.

Also, as shown in the above described FIGS. 3 and 4, the carriage 102 is provided with the injection outlet 134 on the rear side of the horizontal portion 102a, but the injection outlet 134 may be provided around the print head 101, for example, so that the air flow is injected so as to keep the ink away from the print head 101 in the configuration. In this case, since the blower fan 127 is capable of gas flowing so as to keep the ink away from the print head 101 during the ink discharge in the initial printing, the intermediate printing, and the late printing, ink adhesion to the print head 101 caused by splashing back from the print-receiving medium 104 can be prevented. Also, since the blower fan 127 can be used both as the ink-adhesion preventing mechanism and the removing mechanism, the apparatus configuration can be simplified.

Moreover, in this variation, it may be so configured that the CPU 301 controls intensity of the air flow by the blower fan 127 in accordance with the radiation amount of the ultraviolet rays in the finishing processing at Step S165 and Step S200. For example, by controlling the blower fan 127 so that the smaller the radiation amount of the ultraviolet rays in the finishing processing, the weaker air flow is generated, a strong air flow is prevented from hitting the ink on the outer surface, whose cured degree is low and which is still soft and the decoration material on the outer surface can be prevented from advertently sinking into the ink. If the cured degreed is low, a large amount of decoration material is sprayed in usual, and it is likely that the decoration material remains by weakening the air flow as above, but in this case, the decoration material can be removed by separate removing device as will be described below, for example.

(3) Decoration-material removing device other than the blower fan:

In the variation (2), the air flow by the blower fan 127 is used so as to remove the excessive decoration material, but a removing device (not shown) for removing the excess decoration material may be separately provided. As this removing device, an adsorption removing device of the metal decoration material using static electricity or a recovering device of the decoration material using vibration, for example, can be employed.

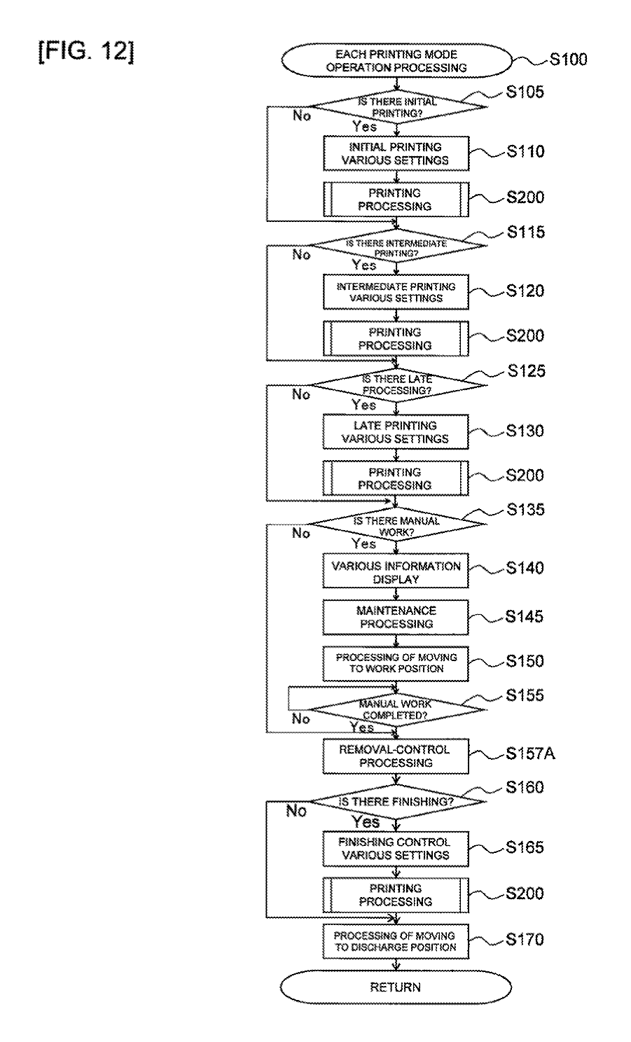

FIG. 12 is a flowchart illustrating a detailed content of each printing mode operation processing in this variation and corresponds to the above described FIG. 11. In FIG. 12, a difference from the above described FIG. 11 is that Step S157A is provided instead of Step S157. At this Step S157A, the CPU 301 outputs a driving signal to a removing-device driving circuit (not shown) through the output interface 305 so as to drive the removing device. The removing device removes the decoration material in a movable state with respect to the outer surface of the ink cured by the radiation of the ultraviolet rays by the UV radiating device 121.

(4) If a curing stage of the ink, not the radiation amount, is set:

In the above described embodiment, the CPU 301 sets the radiation amount corresponding to the printing mode selected by the operator. However, the curing stage of the ink is not constant even with the same radiation amount depending on a type of the ink, a use environment, the type of a solid element, a type of a storage medium and the like. According to the degree of the curing stage, a degree of close contact of the decoration material to the ink and time until the ink is fully cured are changed. In this variation, the curing stage of the ink is set in view of the above points.

Specifically, if the operator has selected the printing mode through the operating means of the PC 320, the CPU 301 sets the curing stage of the ink in the initial printing, the intermediate printing, and the late printing at Step S110. Then, the CPU 301 controls the UV radiating device 121 so as to radiate the ultraviolet rays in the radiation amount corresponding to the set curing stage. It may be so configured that, instead of the mode selection operation by the operator as above, the image data includes data that specifies a curing stage, and by means of selection by the operator of an image to be printed, the CPU 301 realizes the curing stage according to the data included in the image data, for example.

According to this variation, the curing stage of the ink can be reliably set to a stage desired by the operator in a form corresponding to the various variations.

(5) If the radiation amount is set according to a period and a time point:

In the above described embodiment, the radiation amount set in advance in accordance with the printing mode is set through selection by the operator of the printing mode, but it may be so configured that, instead of the setting of the radiation amount through the selection from the fixed set values as above, the radiation amount can be arbitrarily set by input by the operator of a period or a time point relating to the adhesion of the outer surface of the ink on the print-receiving medium 104.

For example, in the printing modes “7” to “12” shown in FIG. 9, since the radiation-amount adjustment % for the finishing is set to 100% for all, the printing layer of the print-receiving medium 104 at the stage in which the printing processing has been finished is in the “fully cured” state. However, there may be cases in which the “fully cured” state is not required immediately after the printing due to circumstances such that the printing time cannot be ensured long, a completed product after the printing is not directly delivered but will be sent and the like. Therefore, in this variation, the radiation amount by the UV radiating device 121 is set so that the ink is “fully cured” at a time point when the operator wants to obtain the completed product in the end (at a time point when the product reaches a destination, for example). Specifically, when the operator inputs the time point when he/she wants to obtain the completed product in the end (or a time period from the current time to that time) through the operating means of the PC 320, the CPU 301 obtains period or time-point information at Step S110 and sets the radiation amount on the basis of the information. The CPU 302 makes this setting on the basis of a correlation table indicating a correlation between the initial radiation amount set for each ink type (composition) and time required for the fully curing (the table not shown. The RAM 303 stores in an appropriate storage area). Then, the CPU 301 sets the radiation amount for the finishing processing in the data table of the selected printing mode to the above described radiation amount.

For example, if the operator has selected the printing mode “11” in FIG. 9 and the radiation amount set on the basis of the time point of the input by the operator is 80%, the radiation-amount adjustment % for the finishing in the printing mode “11” is changed from “100” to “80”. As a result, the curing stage of the ink the operator wants to obtain in the end can be reliably obtained at timing desired by the operator. Also, since there is no need for “fully curing” in the finishing, the printing time can be reduced.

(6) Others:

In the above, arrows shown in FIG. 5 illustrate an example of a flow of signals and do not limit the flow direction of the signals. Also, the flowcharts shown in FIGS. 6 to 8 and 10 to 12 and the like do not limit the present invention to the procedures shown in the flows, but addition/deletion or change of the order and the like of the procedure is possible within a range not departing from the gist and technical idea of the invention.

Though not particularly described in the above, the print-receiving medium 104 in the above described embodiment includes an intermediate body having separation properties with respect to the ink for transfer of the ink to the print-receiving medium 104 and circulating within the inkjet recording apparatus 100. Also, if the placing table 105 itself has the separation properties with respect to the ink, it may be so configured that the placing table 105 is used as the print-receiving medium 104 and the ink, which is a printing result, is separated from the surface of the placing table 105 and transferred to another object.

In the above described embodiment, the radiation amount is changed by controlling the current value or the number of turned-on lights of the UV radiating device 121, but not limited to that, the radiation amount reaching the ink may be adjusted by shielding the ultraviolet rays by some means and having the remainder pass while the radiation amount of the ultraviolet rays generated by the UV radiating device 121 is kept constant.

As for the “fully curing” described in the above, the radiation amount of the ultraviolet rays to the ink is determined, considering a relative relationship between the cured state of the ink and the adhesion for a time factor, but the other factors may be considered with the time factor. An ambient temperature of the printing result (including heat generated by the heater 129, the auxiliary heater 132, the UV-LED 121a, the various motors 108, 111 and the like of the inkjet recording apparatus 100) may be also considered as a factor that advances the curing of the ink.

As for the type of the print-receiving medium 104, the configuration of the printing layer, the color/amount of the ink, the radiation amount of the ultraviolet rays and the like, the data table stored in the predetermined storage areas of the RAM 303 may be supplied from the outside to the inkjet recording apparatus 100 through a network or a storage medium or may be input by the operator in the inkjet recording apparatus 100. The ultraviolet-ray radiation amount is appropriately determined, in relation with the composition and application of the ink, in accordance with a correlation between the cured degree (adhesion degree) of the ink and at least one of a temperature and an elapsed time. A program of the inkjet recording apparatus 100 may be so configured that the ultraviolet-ray radiation amount can be automatically obtained in accordance with the above relation and in accordance with at least one of the temperature and the elapsed time. The program of the inkjet recording apparatus 100 may be so configured that a data table corresponding to the result of experiments repeated in accordance with at least one of the temperature and the elapsed time by changing the ultraviolet-ray radiation amount to the ink in many ways is produced so that the ultraviolet-ray radiation amount can be determined or input automatically or manually.

Also, other than those already described above, methods according to the above described embodiment and variations may be combined and used as appropriate.

What is claimed is:

1. A recording apparatus comprising:
a placing device capable of placing a recording medium;
a discharging device having a nozzle that discharges ink which progresses curing while generating adhesion upon a trigger of radiation of ultraviolet rays and has adhesion on an outer surface thereof till a predetermined curing stage;
a radiating device that radiates the ultraviolet rays;
a driving device that moves said placing device;
a batch control portion that controls said discharging device and said radiating device so as to discharge said ink onto an outer surface of said recording medium placed by said placing device and to radiate ultraviolet rays in a predetermined first radiation amount to said ink adhering to said recording medium;
a primary control portion that controls said discharging device and said radiating device so as to discharge said ink onto the outer surface of said recording medium placed by said placing device and to radiate ultraviolet rays in a second radiation amount smaller than said first radiation amount to said ink adhering to said recording medium instead of said batch control portion;
a secondary control portion that controls said driving device so as to move said placing device, after the discharge of said ink and the radiation of said ultraviolet rays executed by control of said primary control portion, from a processing area capable of the discharge and the radiation to a work area where an operator can perform a spraying work of a solid element larger than a diameter of said nozzle to the adhering ink; and
a tertiary control portion that controls said driving device and said radiating device so as to move said placing device from said work area to said processing area, after the movement of said placing device to said work area executed by the control of said secondary control portion, and to radiate said ultraviolet rays to at least a part of the outer surface of the ink of said recording medium till said predetermined curing stage is exceeded.

2. The recording apparatus according to claim 1, further comprising
a mode setting portion that sets either one of a batch recording mode of executing the discharge of said ink and the radiation of said ultraviolet rays by the control of said batch control portion and a multistage recording mode of executing the discharge of said ink and the radiation of said ultraviolet rays by the control of said primary control portion, the movement of said placing device by the control of said secondary control portion, and the radiation of said ultraviolet rays by the control of said tertiary control portion, characterized in that
in said batch recording mode, said batch control portion sets said first radiation amount to a minimum value of the radiation amount when a tension load of the ink in an evaluation by a tacking tester in compliance with JIS Z3284 becomes zero; and
in said multistage recording mode, said primary control portion sets said second radiation amount to within a range of 0.05 to 0.95 times of the minimum value of the radiation amount when a tension load of the ink in an evaluation by a tacking tester in compliance with JIS Z3284 becomes zero.

3. The recording apparatus according to claim 1, further comprising
a radiation stop portion that stops the radiation of the ultraviolet rays by said radiating device in a state in which said driving device has moved said placing device to the work area by the control of said secondary control portion.

4. The recording apparatus according to claim 1, further comprising
a maintenance execution portion that causes said discharging device to execute a predetermined maintenance operation in a state in which said driving device has moved said placing device to the work area by the control of said secondary control portion.

5. The recording apparatus according to claim 1, further comprising
a notifying portion that notifies information relating to the control by said tertiary control portion in a state in which said driving device has moved said placing device to the work area by the control of said secondary control portion.

6. A recording apparatus comprising:
a placing device capable of placing a recording medium;
a discharging device having a nozzle that discharges ink which progresses curing while generating adhesion upon a trigger of radiation of ultraviolet rays and has adhesion on an outer surface thereof till a predetermined curing stage;
a radiating device that radiates the ultraviolet rays;
a spraying device that splays a solid element larger than a diameter of said nozzle;
a first control portion that controls said discharging device and said radiating device so as to discharge said ink onto an outer surface of said recording medium placed by said placing device and to radiate the ultraviolet rays in a radiation amount smaller than a radiation amount to achieve said predetermined curing stage to said ink adhering to said recording medium;
a second control portion that controls said spraying device so as to spray said solid element to said adhering ink, after the discharge of said ink and the radiation of said ultraviolet rays executed by the control of said first control portion; and
a third control portion that controls said radiating device so as to radiate said ultraviolet rays, after the spraying executed by the control of said second control portion till said predetermined curing stage is exceeded, to at least a part of the outer surface of the ink on said recording medium.

7. The recording apparatus according to claim 6, wherein:
said first control portion controls said radiating device so as to decrease the radiation amount if a sprayed amount of said solid element by said spraying device on the basis of the control of said second control portion is large, and to increase the radiation amount if a sprayed amount of said solid element by said spraying device on the basis of the control of said second control portion is small.

8. The recording apparatus according to claim 1, further comprising:
a flowing device that causes a gas to flow toward said recording medium placed on said placing device; and
a flow control portion that controls said flowing device so as to execute the gas flowing after the execution of control by the secondary control portion and before completion of the radiation of the ultraviolet rays on the basis of the control by the tertiary control portion.

9. The recording apparatus according to claim 8, wherein:
said flow control portion controls said flowing device so as to cause the gas to flow toward the radiating device, during the radiation of the ultraviolet rays by the radiating device on the basis of the control by the primary control portion.

10. The recording apparatus according to claim 8, wherein:
said flow control portion controls said flowing device so as to cause the gas to flow in a direction in which the ink discharged by said discharging device is away from the discharging device, on the basis of the control by the primary control portion.

11. The recording apparatus according to claim 7, wherein:
said flow control portion controls said flowing device so as to generate the weaker air flow, the smaller the radiation amount of the ultraviolet rays by said radiating device on the basis of the control by the tertiary control portion.

12. The recording apparatus according to claim 1, further comprising:
a removing device that removes said solid element movable with respect to the outer surface of the ink having been cured by the radiation of the ultraviolet rays by said radiating device on the basis of the control by the primary control portion; and
a removal control portion that controls said removing device so as to remove said solid element after the execution of control by the secondary control portion and before the completion of the radiation of the ultraviolet rays on the basis of the control by the tertiary control portion.

13. The recording apparatus according to claim 1, further comprising:
a moving device that relatively moves said placing device and said radiating device; and
a movement control portion that controls said moving device so as to relatively move said placing device and said radiating device during the radiation of the ultraviolet rays by the radiating device on the basis of the control by the tertiary control portion.

14. The recording apparatus according to claim 1, further comprising:
a curing-degree setting portion that sets a curing stage of the ink by the radiation of the ultraviolet rays by the radiating device on the basis of the control by the primary control portion, wherein
the primary control portion controls said radiating device so as to radiate the ultraviolet rays in a radiation amount corresponding to the setting by said curing-degree setting portion.

15. The recording apparatus according to claim 1, wherein:
said ink is cured over time;
said recording apparatus further comprises time-information obtaining portion that obtains time point information or period information relating to adhesion on the outer surface of the ink on said recording medium; and
the tertiary control portion controls said radiating device so as to radiate the ultraviolet rays in a radiation amount to realize the adhesion corresponding to said time point information or said period information obtained by said time information obtaining portion.

16. The recording apparatus according to claim 1, wherein:
said discharging device discharges said ink of cation series containing at least one of an epoxy compound, an oxetane product and vinyl ether product, a polymerization initiator, and a sensitizer.

17. The recording apparatus according to claim 1, wherein:
the tertiary control portion controls said radiating device so as to radiate said ultraviolet rays till a stage in which a tension load of the ink in an evaluation by a tacking tester in compliance with JIS Z3284 becomes zero as said predetermined curing stage is exceeded.

18. The recording apparatus according to claim 1, wherein:
the primary control portion controls said radiating device so as to radiate the ultraviolet rays in a radiation amount within a range of 0.05 to 0.95 times of the minimum value of the radiation amount when a tension load of the ink in an evaluation by a tacking tester in compliance with JIS Z3284 becomes zero.

19. The recording apparatus according to claim 1, wherein:
said solid element is made of any of ceramic, resin and metal and is formed in a shape of at least one of a particle, a film, a powder and a fiber.

20. A recording method comprising:
a first step of discharging ink which progresses curing while generating adhesion upon a trigger of radiation of ultraviolet rays and has adhesion on an outer surface thereof till a predetermined curing stage, from a nozzle to an outer surface of a recording medium, and radiating the ultraviolet rays in a radiation amount smaller than a radiation amount to achieve said predetermined curing stage to said ink adhering to said recording medium;
a second step of spraying a solid element larger than a diameter of said nozzle to said adhering ink, after the discharge of said ink and the radiation of said ultraviolet rays in said first step; and
a third step of radiating said ultraviolet rays to at least a part of the outer surface of the ink on said recording medium, after said spraying in said second step till said predetermined curing stage is exceeded.
